(19) United States
(12) Patent Application Publication
(10) Pub. No.: US 2014/0316747 A1
(43) Pub. Date: Oct. 23, 2014

(54) SIMULATION OF CIVIL INFRASTRUCTURE

(71) Applicant: SIEMENS AKTIENGESELLSCHAFT, Munchen (DE)

(72) Inventors: Birgit Obst, Munchen (DE); Tim Schenk, Landshut (DE); Roland Rosen, Herrsching (DE); Stefan Boschert, Munchen (DE); Veronika Brandstetter, Munchen (DE); Jorg Nieveler, Munchen (DE); Moritz Allmaras, Munchen (DE); Thomas Gruenewald, Somerset, NJ (US); George Lo, Plainsboro, NJ (US)

(73) Assignee: Siemens Aktiengesellschaft, Munchen (DE)

(21) Appl. No.: 13/865,777

(22) Filed: Apr. 18, 2013

(51) Int. Cl. G06F 17/50

(52) U.S. Cl. CPC G06F 17/5004
USPC 703/1

(57) ABSTRACT

Method for generating boundary conditions for at least one model for the simulation of at least one civil infrastructure, said method comprising the process steps: (a) mapping of spatially distributed installations connected to the at least one civil infrastructure onto a data structure; (b) typification of the spatially distributed installations; and (c) determination of boundary conditions for the at least one model by means of the spatially distributed installations that have been typified.

### TECHNICAL FIELD

The present disclosure relates to the technical field of the simulation of civil infrastructure.

### BACKGROUND

Model-based simulation can be used to describe the technical performance of civil, in particular of urban, infrastructures. Such infrastructures are, for example transport networks (transport networks for transport by road or public transport networks), water networks (for the distribution of drinking water or collection of wastewater), energy supply systems (these can be centralized or decentralized, and/or distributed by one producer or, in particular in the case of renewable energy, by different producers to consumers in electricity supply grids).

The focus of model-based evaluation is on the evaluation of effects of potential improvement measures on urban infrastructures. The improvement measures can be, for example, structural, legal or financial in nature and directed at overarching objectives, such as, for example, the protection of the environment or the reduction of the consumption of resources. Since these measures usually relate to various levels of abstraction and to various urban fields of activity, the relationships and dependencies between various infrastructures should be described. For example, the consumption of water or energy during a day depends on whether people are in the office or at home, are on a journey or stationary in a traffic jam. Moreover, the use of electric vehicles with a corresponding charging profile via charging stations has effects on the utilization of the capacity of electricity grids.

In order to analyze and evaluate defined scenarios relating to these complex relationships it is necessary to provide specific input data and boundary conditions. Carrying out such data acquisition extensively over an entire city and over periods of several years for example, can be very expensive or even unworkable since there is no extensive and continuous measurement data available for all fields of activity via sensors, video cameras or suchlike.

For traffic simulations, test data is normally acquired by means of traffic counts or transport surveys in a time-consuming and expensive process, in order to obtain examples of origin-destination relationships as input data for traffic models. This input data is used to model the real traffic demand in the reference area that is under consideration.

For the simulation of drinking water distribution networks and energy networks, the annual consumer consumption has to be converted statistically into monthly-based, weekly-based or daily-based consumer profiles, or individual random samples have to be extrapolated.

This laborious acquisition of necessary input data and boundary conditions is carried out separately for each area of activity, that is, for each individual urban infrastructure.

### SUMMARY

One embodiment provides a method for generating boundary conditions for at least one model for the simulation of at least one civil infrastructure, said method comprising the process steps: (a) mapping of spatially distributed installations connected to the at least one civil infrastructure onto a data structure; (b) typification of the spatially distributed installations; and (c) determination of boundary conditions for the at least one model by means of the spatially distributed installations that have been typified.

In a further embodiment, the installations are connected to a plurality of the infrastructures, and wherein by means of the typification of the spatially distributed installations that have been mapped, boundary conditions for models of different civil infrastructures are derived.

In a further embodiment, at least one occupancy profile is determined for each of the mapped spatially distributed installations on the basis of the typification, and on the basis of the occupancy profile that has been determined or on the basis of the occupancy profiles that have been determined, boundary conditions are determined for models of different civil infrastructures.

In a further embodiment, the spatially distributed installations include a building, a plot of land and/or an infrastructure location.

In a further embodiment, the mapping of spatially distributed installations onto the data structure and/or the typification of the spatially distributed installations that have been mapped is carried out by means of data from a geographic information system, from municipal building authorities, from a land registry and/or from another data server such as Google, Open Street Map and/or CityGML.

In a further embodiment, the spatially distributed installations include buildings, and the process step (b) includes an assignment of one or of a plurality of classification criteria to one, to a plurality of, or to all of the spatially distributed buildings that have been mapped, wherein example classification criteria include, for example, a use of the building, a land use, a building construction method, a building material used, an age of the building, an installed infrastructure link and/or a user type.

In a further embodiment, the civil infrastructure or the civil infrastructures include a network, e.g., a transport network, a public transport network, an electricity grid, a water supply, a wastewater network, a district heating network and/or a gas supply network.

In a further embodiment, the model or models map flows occurring in the civil infrastructure simulated by the respective model and the boundary conditions map sources and sinks of these flows and/or sources and sinks of these flows can be determined from the boundary conditions.

In a further embodiment, the method includes the process step of a quantitative anchoring of the model, by, for example the total of all the flows being set at zero and/or by absolute values for the flows being determined by means of the boundary conditions.

In a further embodiment, the spatially distributed installations are spatially distributed across an urban area.

Another embodiment provides a system for the generation of boundary conditions for at least one model of at least one civil infrastructure, the system including: a mapping means for mapping spatially distributed installations connected to the at least one civil infrastructure onto a data structure; a typification means for the typification of the spatially distributed installations; and a determination means for the determination of boundary conditions for the at least one model by means of the spatially distributed installations that have been typified.

In a further embodiment, the mapped installations are connected to a plurality of the infrastructures, and wherein by means of the typification of the mapped spatially distributed installations, boundary conditions are derivable for models of different civil infrastructures.

In a further embodiment, for each of the mapped spatially distributed installations at least one occupancy profile is determined on the basis of the typification, and by means of the occupancy profile that has been determined or the occupancy profiles that have been determined, boundary conditions for models of different civil infrastructures are determined.

In a further embodiment, the spatially distributed installations include buildings, plots of land and/or infrastructure locations.

In a further embodiment, the system includes an interface, via which the mapping means and/or the typification means is connectable to a geographic information system, to an information system of city building authorities, of a land registry and/or of another data server such as Google, Open Street Map and/or CityGML.

In a further embodiment, the spatially distributed installations include buildings and the typification means is adapted to assign one or a plurality of classification criteria to one, to a plurality of, or to all of the spatially distributed buildings that have been mapped, example classification criteria including a use of the building, a land use, a building construction method, a building material used, an age of the building, an installed infrastructure link and/or a user type.

In a further embodiment, the at least one civil infrastructure includes a network, e.g., a transport network, a public transport network, an electricity grid, a water supply, a wastewater network, a district heating network and/or a gas supply network.

In a further embodiment, the model or models maps flows occurring in the civil infrastructure simulated by the respective model and the boundary conditions map sources and sinks of these flows and/or sources and sinks of these flows are determinable from the boundary conditions.

In a further embodiment, the determination means is adapted to carry out a quantitative anchoring of the model, by, for example, the total of all the flows being set at zero and/or by absolute values for the flows being determinable by means of the boundary conditions.

In a further embodiment, the spatially distributed installations are spatially distributed across an urban area.

### BRIEF DESCRIPTION OF THE DRAWINGS

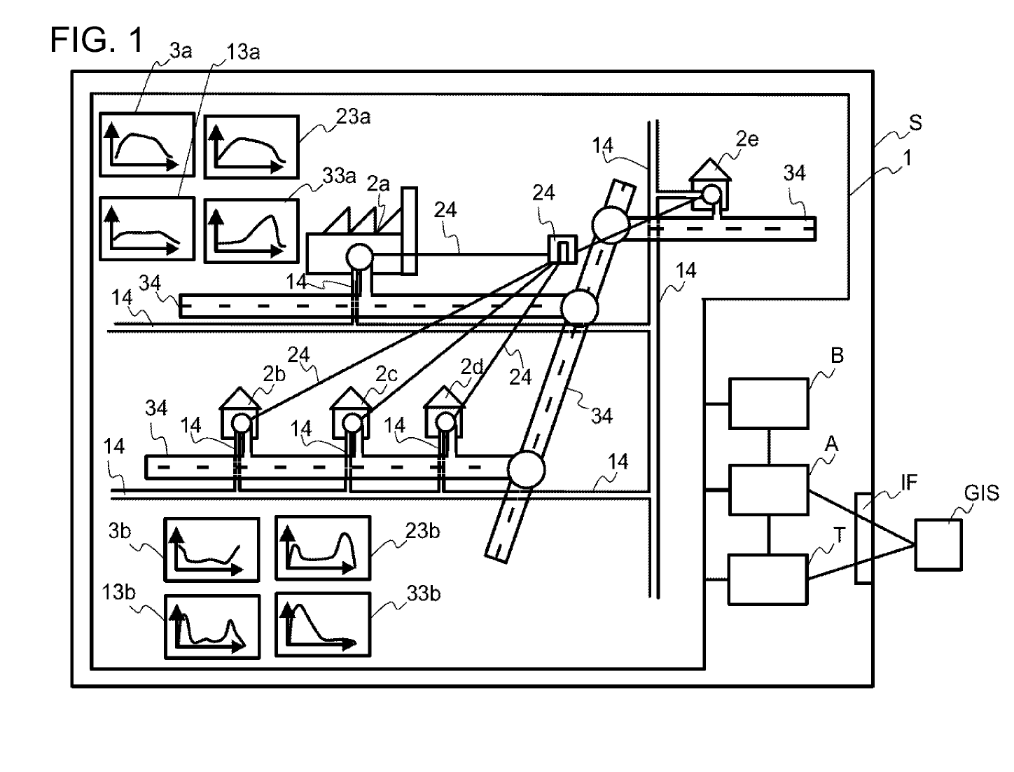

An exemplary embodiment will be explained in more detail below with reference to FIG. 1, which shows an example system for the generation of boundary conditions for a model for the simulation of a civil infrastructure.

### DETAILED DESCRIPTION

Embodiments of the present disclosure may simplify the provision of boundary conditions for a model for the simulation of a civil infrastructure.

According to a first aspect, a method for the generation of boundary conditions for at least one model is proposed. The model simulates at least one civil infrastructure. For this purpose, spatially distributed installations that are connected to the at least one civil infrastructure are typified and mapped onto a data structure. By means of said typified spatially distributed installations, boundary conditions are determined for the at least one model by means of said typified spatially distributed installations.

According to a further aspect, a system for the generation of boundary conditions for at least one model of at least one civil infrastructure is proposed. Spatially distributed installations are connected to the at least one civil infrastructure. The system includes a mapping means, a typification means and a determination means. The mapping means is adapted to represent the spatially distributed installations onto a data structure. The typification means is adapted to typify the spatially distributed installations. The determination means is adapted to determine boundary conditions for the at least one model using the spatially distributed installations that have been typified.

Example aspects of the invention are described in more detail hereafter using FIG. 1 by way of example.

FIG. 1 (FIG. 1) shows an embodiment of a system for generating boundary conditions.

Various embodiments and variants of the system and of the method are explained with the aid of FIG. 1.

FIG. 1 shows an example of a system S for the generation of boundary conditions 3a, 13a, 23a, 33a, 3b, 13b, 23b, 33b for at least one model of at least one civil infrastructure 14, 24, 34. The civil infrastructures covered include a drinking water supply network 14, an electricity supply grid 24 and a road traffic network 34.

The system S includes a mapping means A, a typification means T and a determination means B and is connected to an external system, to a geographic information system (GIS), for example.

For the connection to the external GIS system, the system S includes an interface IF, via which the mapping means A and/or the typification means T is/are connectable to the GIS. Instead of a GIS, the system S may also be connected to a different external system, for example to an information system operated by city building authorities, by a land registry and/or by another data server such as Google, Open Street Map and/or CityGML.

Installations 2a, 2b, 2c, 2d, 2e distributed spatially across an urban area and configured as buildings are connected to the at least one civil infrastructure 14, 24, 34. Spatially distributed installations may also include other installations that are connectable to a civil infrastructure, for example, sites with no buildings, such as parking lots, construction sites, or other infrastructure locations. Installation 2a is a building in which, predominantly or exclusively, work is carried out, for example, an industrial building such as a factory or an office building. Installations 2b, 2c, 2d, 2e are residential buildings in which, predominantly or exclusively, the use is residential.

The mapping means A is adapted to represent the spatially distributed installations 2a, 2b, 2c, 2d, 2e onto a data structure 1. The data structure 1 is incorporated in the at least one model, or the data structure 1 is the at least one model.

The mapping of spatially distributed installations 2a-2e onto the data structure 1 and/or the typification of the spatially distributed installations 2a-2e can be carried out in a particularly efficient manner using data from the external GIS system.

The typification means T is adapted to typify the spatially distributed installations 2a-2e. In the present example, the types of building are subdivided into industrial buildings and residential buildings. The typification means T assigns the building type ‘industrial building’ to building 2a, whilst it assigns the building type ‘residential buildings’ to buildings 2b-2e.

It is irrespective whether the typification is carried out first using the typification means and mapping is subsequently done using the mapping means, or whether mapping is done first using the mapping means and subsequently the typification is carried out using the typification means, or whether mapping and typification are done simultaneously.

The determination means B is adapted to determine boundary conditions for the at least one model using the spatially distributed installations that have been typified. For this purpose, the determination means determines various boundary condition profiles 3a, 13a, 23a, 33a, 3b, 13b, 23b, 33b on the basis of the typifications of the installations 2a-2e that have been carried out by the typification means. Here the boundary condition profiles 3a, 13a, 23a, 33a, 3b, 13b, 23b, 33b are determined for the different building types 2a-2e for different urban infrastructures 14, 24, 34, to which the buildings 2a-2e are connected. Boundary condition profiles include occupancy profiles 3a, 3b, drinking water demand 13a, 13b, electricity consumption 23a, 23b and transport demand 33a, 33b. In FIG. 1, the occupancy profiles 3a, 13a, 23a, 33a describe occupancy profiles for the installation type ‘industrial building’, while the occupancy profiles 3b, 13b, 23b, 33b describes the installation type ‘residential buildings’.

The typification of the installations and/or the mapping of the installations onto the data structure and/or the determination of boundary conditions using the spatially distributed installations that have been typified may be automated and/or carried out automatically.

The civil installations 2a-2e mapped onto the data structure 1 are connected to the drinking water supply network 14, to the electricity supply network 24, and to the road traffic network 34. By means of the typification of the spatially distributed installations 2a-2e that have been mapped, the boundary conditions 3a, 13a, 23a, 33a, 3b, 13b, 23b, 33b are derived for models of the drinking water supply network 14, of the electricity supply network 24, and of the road traffic network 34.

According to one embodiment, at least one occupancy profile 3a, 3b is determined on the basis of the typification for each of the mapped spatially distributed installations 2a-2e. By means of the occupancy profiles 3a, 3b that have been determined, boundary condition profiles 13a, 23a, 33a, 13b, 23b, 33b are determined for models of different civil infrastructures 14, 24, 34. It is possible, for example, from the occupancy profile 3a, 3b of a building, that is, from a profile of the trends over time in its occupancy, to determine profiles for the drinking water demand 13a, 13b, profiles for the electricity consumption 23a, 23b and profiles for the transport demand.

The boundary condition profiles 3a, 13a, 23a, 33a, 3b, 13b, 23b, 33b are determined by means of the typification of the spatially distributed installations, for example, by the typification means T assigning one or a plurality of classification criteria to one, to a plurality of, or to all of the spatially distributed buildings that have been mapped. As a result thereof it is possible, by means of appropriate classification criteria, to determine boundary conditions for the models of the civil infrastructures that have been considered at a considerably reduced cost. Appropriate classification criteria include, for example, a use of the building, land use, the building construction method, the building material used, the age of the building, the infrastructure links that have been installed and/or a user type.

The at least one civil infrastructure 14, 24, 34 may be configured as a network or includes one or a plurality of networks, for example, a transport network, a public transport network, an electricity grid, a water supply, a wastewater network, a district heating network and/or a gas supply network. For this purpose, the model or models can map the flows occurring in the civil infrastructure 14, 24, 34 simulated by the respective model. The boundary conditions 3a, 13a, 23a, 33a, 3b, 13b, 23b, 33b can represent sources and sinks of these flows and/or sources and sinks of these flows can be determinable from the boundary conditions.

The determination means B can be adapted to carry out a quantitative anchoring of the model by, for example, the total of all flows being set at zero and/or by absolute values for the flows being determinable by means of the boundary conditions 3a, 13a, 23a, 33a, 3b, 13b, 23b, 33b. This can be carried out, for example, in such a way that boundary condition profiles 3a, 13a, 23a, 33a, 3b, 13b, 23b, 33b are assigned to each of the installations 2a-2e by means of the typifications, the boundary condition profiles 3a, 13a, 23a, 33a, 3b, 13b, 23b, 33b reflecting a course over time of the degree of capacity utilization for the respective installation and the capacity utilization being given as a percentage value of from 00-1000 or with a value between 0 and 1. For example, the occupancy profiles 3a, 3b may describe the occupancy of a building from 0-100% in the course of a day, the typical occupancy profile 3a being assigned to each industrial building 2a, whilst the occupancy profile 3b is assigned to each residential building. For each of the buildings 2a-2e, its absolute occupancy in the course of a day can be simulated by multiplying its occupancy profile (3a or 3b) by a number of users that corresponds to a full occupancy level. From the absolute occupancy levels it is possible in turn to determine absolute profiles for the energy consumption, for the transport demand or for the drinking water consumption. Likewise, however, from the occupancy profiles 3a, 3b for each of the buildings 2a-2e, it is possible to determine the drinking water demand thereof 13a, 13b, the electricity consumption thereof 23a, 23b and the transport demand thereof 33a, 33b, initially in a temporal relative value profile. By means of the temporal relative value profiles, the drinking water demand, the electricity consumption and transport demand are determined in absolute values, using a value that corresponds to the full occupancy of the respective building. From a mathematical viewpoint and in the scope of this document, here the boundary condition profiles 3a, 13a, 23a, 33a, 3b, 13b, 23b, 33b, and also profiles derived therefrom, for example as described using absolute values or profiles from other appropriate mapping of the profile of individual installations 2a-2e, are boundary conditions. In an example embodiment, the absolute values for the profiles integrated in total represent the civil/urban total consumption/total demand. In other words, the individual profiles and input data must be specified in absolute values of appropriate units, using statistical totals such as the number of inhabitants of the town or of the district, the demographic structure, the number of vehicles, also subdivided according to types of vehicle, total energy consumption, total water consumption, etc.

According to a further embodiment, spatially distributed installations 2a-2e connected to a civil infrastructure 14, 24, 34 are typified. The typified installations are then mapped onto a data structure 1. Boundary conditions 3a, 13a, 23a, 33a, 3b, 13b, 23b, 33b for the at least one model are then determined automatically by means of the spatially distributed installations 2a-2e that have been typified.

The civil installations 2a-2e may be connected at the same time to different infrastructures 14, 24, 34, which is mapped accordingly in the data structure 1. By means of the typification of the spatially distributed installations 2a-2e that have been mapped, boundary conditions 3a, 13a, 23a, 33a, 3b, 13b, 23b, 33b are derived for models of the different civil infrastructures 14, 24, 34. In this way, multidomain boundary condition models can be generated with little effort.

At least one occupancy profile 3a, 3b may be determined on the basis of the typification for each of the spatially distributed installations 2a-2e that has been mapped. Using the occupancy profile 3a, 3b that has been determined or the occupancy profiles 3a, 3b that have been determined, boundary conditions 13a, 23a, 33a, 13b, 23b, 33b for models of different civil infrastructures 14, 24, 34 are determined.

For most urban technical infrastructures, such as for example, for the infrastructures 14, 24, 34 described by means of FIG. 1, a building or plot of land (plots of land and likewise other appropriate installations are hereafter also referred to as buildings) represents a boundary node, which also defines the necessary boundary conditions. With a model for boundary conditions in the building and using this building as a boundary node for different domains/infrastructures, a closed system with interaction between different infrastructures can be described using these boundary nodes.

Therefore, according to one embodiment, the building is first typified, for example, by means of an appropriate selection of the following classification criteria:
Use of the building, subdivided for example, into an appropriate selection of the classes: residential, industrial, commercial, public or semi-public parking lot, recreational facility;
construction method
material used
age
installed infrastructure links, subdivided for example, into an appropriate selection of the classes: energy, electricity, water, gas, parking lots, road links, and so on
type of user, subdivided for example, into an appropriate selection of the classes: student, individual or family, employee or freelance, unemployed, pensioner, and so on.

From building data that is relatively easy to obtain (for example, from data from geographic information systems (GISs), from municipal building authorities, from a land registry and/or from another data server such as Google, Open Street Map and/or CityGML), the distribution of the typified buildings across an urban area can then be determined. It is also possible to map conurbations or other areal aggregations.

Using defined models, the various boundary condition profiles and input data can be derived for each building type in an automated manner and also without the need for human interaction. This derived data can be used as input parameters for simulations of different technical or civil infrastructures.

### Example

A residential building with mainly employed people as inhabitants has a typical occupancy profile with dynamic alternations, that is, a high occupancy by night and a low occupancy by day. An office building on the other hand has a contrasting occupancy profile with low occupancy by night and high occupancy by day. On the basis of these occupancy profiles, the different boundary conditions for different civil infrastructures can be derived. For example, the water consumption in a residential building will be increased in the mornings and evenings. For office buildings, it can be assumed that there is an increased water consumption during the daytime. The energy consumption profile is derived in a similar manner. In exactly the same way the road traffic flow will be of interest. It is assumed that people travel from their place of residence to a place of work (an office building, for example) in the morning and in the opposite direction in the evening, possibly with a detour to a commercial building, such as a supermarket, for example. In this way the input data for a traffic model can be derived. Occasionally electric vehicles have to be charged, in a parking lot for an office building, for example. Therefore the charging and the associated energy consumption for electric vehicles, in a parking lot for the office building, for example can be taken into account.

The individual profiles and input data then have to be itemized in absolute values of suitable units, using statistical total values, such as the number of inhabitants of the town or of the district, the demographic structure, the number of vehicles, also subdivided according to types of vehicle, total energy consumption, total water consumption, etc.

With this method, the boundary conditions and input data for different domains/infrastructures are generated by models for the different building types with their particular characteristics (via defined parameters). This method provides a comprehensive and consistent description for input data in order to represent and display an integrated holistic system together with the relationships and interactions thereof. Since the boundary conditions can also be influenced by other infrastructures, the boundary conditions can even be dynamically adapted using this method.

Based on some embodiments, an important step lies in achieving extensively distributed boundary conditions by means of the typification of installations (such as buildings, plots of land or infrastructure locations) and combining this data for different infrastructures in the installations that consequently represent in the model the nodes described by the boundary conditions. This results in the following advantages:
The data can be generated on a widespread basis for any time period required.
The data remains consistent for the model across all infrastructure types.
The interdependencies between the various infrastructure types can be evaluated and adapted dynamically.
This method also takes social factors into account. Therefore the user behavior that essentially defines the boundary conditions can be not only modeled but also influenced.
Time-consuming and costly empirical data acquisition for specific disciplines (infrastructures) can be avoided.

What is claimed is:

1. A method for generating boundary conditions for at least one model for the simulation of at least one civil infrastructure, said method comprising:
(a) mapping of spatially distributed installations connected to the at least one civil infrastructure onto a data structure;
(b) typification of the spatially distributed installations; and
(c) determination of boundary conditions for the at least one model based on the spatially distributed installations that have been typified.

2. The method of claim 1, wherein:
the installations are connected to a plurality of the infrastructures, and
boundary conditions for models of different civil infrastructures are derived based on the typification of the spatially distributed installations that have been mapped.

3. The method of claim 1, wherein:
at least one occupancy profile is determined for each of the mapped spatially distributed installations on the basis of the typification, and
boundary conditions are determined for models of different civil infrastructures based on the occupancy profile that has been determined or on the occupancy profiles that have been determined.

4. The method of claim 1, wherein the spatially distributed installations include at least one of a building, a plot of land, and an infrastructure location.

5. The method of claim 1, wherein at least one of (a) the mapping of spatially distributed installations onto the data structure and (b) the typification of the spatially distributed installations that have been mapped is performed based on data from at least one of a geographic information system, municipal building authorities, a land registry, and another data server.

6. The method of claim 1, wherein:
the spatially distributed installations include buildings, and
the process step (b) includes an assignment of one or of a plurality of classification criteria to one, to a plurality of, or to all of the spatially distributed buildings that have been mapped,
wherein classification criteria include at least one of a use of the building, a land use, a building construction method, a building material used, an age of the building, an installed infrastructure link, and a user type.

7. The method of claim 1, wherein the civil infrastructure or the civil infrastructures include at least one of a a transport network, a public transport network, an electricity grid, a water supply, a wastewater network, a district heating network, and a gas supply network.

8. The method of claim 1, wherein the model or models map flows occurring in the civil infrastructure simulated by the respective model and the boundary conditions map sources and sinks of these flows or sources, and sinks of these flows are determined from the boundary conditions.

9. The method of claim 1, including performing a quantitative anchoring of the model including at least one of (a) setting the total of all the flows at zero and (b) determining absolute values for the flows based on the boundary conditions.

10. The method of claim 1, wherein the spatially distributed installations are spatially distributed across an urban area.

11. A system for the generation of boundary conditions for at least one model of at least one civil infrastructure, the system comprising:
a mapping means for mapping spatially distributed installations connected to the at least one civil infrastructure onto a data structure;
a typification means for the typification of the spatially distributed installations;
a determination means for the determination of boundary conditions for the at least one model by means of the spatially distributed installations that have been typified.

12. The system of claim 11, wherein:
the mapped installations are connected to a plurality of the infrastructures, and
boundary conditions are derivable for models of different civil infrastructures based on the typification of the mapped spatially distributed installations.

13. The system of claim 11, wherein the determination means are configured to:
for each of the mapped spatially distributed installations, determine at least one occupancy profile based on the typification, and
determine boundary conditions for models of different civil infrastructures based on the occupancy profile that has been determined or the occupancy profiles that have been determined.

14. The system of claim 11, wherein the spatially distributed installations include at least one of buildings, plots of land, and infrastructure locations.

15. The system of claim 11, including an interface configured to connect at least one of the mapping means and the typification means to at least one of a geographic information system, an information system of city building authorities, a land registry, and another data server.

16. The system of claim 11, wherein the spatially distributed installations include buildings, and the typification means is configured to assign one or a plurality of classification criteria to one, to a plurality of, or to all of the spatially distributed buildings that have been mapped,
wherein the classification criteria include at least one of a use of the building, a land use, a building construction method, a building material used, an age of the building, an installed infrastructure link, and a user type.

17. The system of claim 11, wherein the at least one civil infrastructure includes at least one of a transport network, a public transport network, an electricity grid, a water supply, a wastewater network, a district heating network, and a gas supply network.

18. The system of claim 11, wherein the model or models maps flows occurring in the civil infrastructure simulated by the respective model and the boundary conditions map sources and sinks of these flows or sources and sinks of these flows are determinable from the boundary conditions.

19. The system of claim 11, wherein the determination means is configured to perform a quantitative anchoring of the model including at least one of (a) setting the total of all the flows at zero and (b) determining absolute values for the flows based on the boundary conditions.

20. The system of claim 11, wherein the spatially distributed installations are spatially distributed across an urban area.
